(19) United States
(12) Patent Application Publication
(10) Pub. No.: US 2026/0019985 A1
(43) Pub. Date: Jan. 15, 2026

(54) EXTENDED LOW POWER MODE ENGAGEMENT USING MAP-AIDING

(71) Applicant: QUALCOMM Incorporated, San Diego, CA (US)

(72) Inventors: Chandrasekhar JAYARAM, Bangalore (IN); Santoshkumar ZALAKE, Bengaluru (IN); Mukesh KUMAR, Bangalore (IN); Srinivas GANGJI, Bangalore (IN)

(21) Appl. No.: 18/769,299

(22) Filed: Jul. 10, 2024

(51) Int. Cl. H04W 64/00; H04L 5/00; H04W 52/02

(52) U.S. Cl. CPC H04W 64/006; H04L 5/0098; H04W 52/0235

(57) ABSTRACT

Aspects presented herein may enable a UE to augment map data to determine the time between fix and/or the radio frequency ON duration for a low power saving mode. In one aspect, a UE determines a first set of parameters associated with a first low power mode based on (1) information from map data, (2) a speed of the UE, and (3) a heading of the UE. The UE compares the first set of parameters associated with the first low power mode with a second set of parameters associated with a second low power mode. The UE applies (1) the first low power mode based on one or more parameters in the first set of parameters exceeding the second set of parameters, or (2) the second low power mode based on the one or more parameters in the first set of parameters not exceeding the second set of parameters.

### TECHNICAL FIELD

The present disclosure relates generally to communication systems, and more particularly, to wireless communication involving positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus determines a first set of parameters associated with a first low power mode based on (1) information from map data, (2) a speed of a user equipment (UE), and (3) a heading of the UE. The apparatus compares the first set of parameters associated with the first low power mode with a second set of parameters associated with a second low power mode. The apparatus applies (1) the first low power mode based on one or more parameters in the first set of parameters exceeding the second set of parameters, or (2) the second low power mode based on the one or more parameters in the first set of parameters not exceeding the second set of parameters.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of global navigation satellite system (GNSS) positioning in accordance with various aspects of the present disclosure.

FIG. 6 is a diagram illustrating an example of a vehicle performing map over the air in accordance with various aspects of the present disclosure.

FIG. 7 is a diagram illustrating an example of a low power mode associated with a GNSS device/receiver in accordance with various aspects of the present disclosure.

FIG. 8 is a diagram illustrating an example of a map aided low power mode in accordance with various aspects of the present disclosure.

FIG. 9A is a diagram illustrating an example scenario of predicting the time between fix (TBF) and/or the radio frequency (RF) ON/OFF duration for a UE in accordance with various aspects of the present disclosure.

FIG. 9B is a diagram illustrating an example scenario of predicting the TBF and/or the RF ON/OFF duration for a UE in accordance with various aspects of the present disclosure.

FIG. 9C is a diagram illustrating an example scenario of predicting the TBF and/or the RF ON/OFF duration for a UE in accordance with various aspects of the present disclosure.

FIG. 10 is a diagram illustrating an example of a three-dimensional (3D) map aided low power mode in accordance with various aspects of the present disclosure.

FIG. 11 is a flowchart of a method of wireless communication.

FIG. 12 is a flowchart of a method of wireless communication.

FIG. 13 is a diagram illustrating an example of a hardware implementation for an example apparatus and/or network entity.

### DETAILED DESCRIPTION

Aspects presented herein may improve the overall power saving for global navigation satellite system (GNSS) devices/receivers by enabling the GNSS devices/receivers to augment map data to determine the RF ON duration (in a duty cycle). Aspects presented herein may provide an adaptive time between fix (TBF) to extend the low power engagement time for GNSS devices/receivers. In other words, aspects presented herein may provide techniques for low power mode optimization for GNSS devices/receivers, which include at least the following aspects: (1) an adaptive lower power mode: in addition to the user position, environment context, uncertainty, TBF/radio frequency (RF) ON/OFF duration may be optimized further based on user-speed/heading along with map data (as the position uncertainty growth can be strongly constrained along the direction of motion), and (2) availability of a three-dimensional (3D) map may further help optimize the TBF/RF OFF/ON duration, timing of the session ON, re-acquisition resource allocation based on the space vehicle (SV) visibility. For example, at the start of a fresh fix session, a GNSS device/receiver may be configured to predict an SV visibility for a finite time horizon, and use the predicted SV visibility to modify the TBF/RF ON/OFF duration. In addition, the GNSS device/receiver may also be configured to consider quality of service (QOS) or accuracy specification in the determination of optimizing the TBF/RF ON parameters. The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

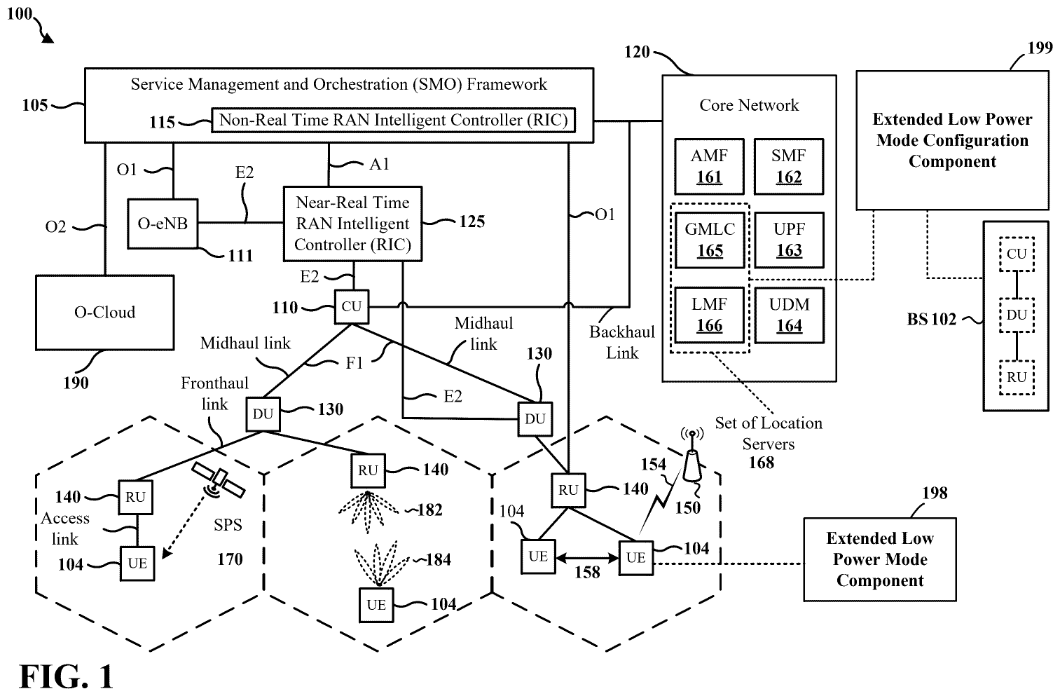

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an extended low power mode component 198 that may be configured to determine a first set of parameters associated with a first low power mode based on (1) information from map data, (2) a speed of the UE, and (3) a heading of the UE; compare the first set of parameters associated with the first low power mode with a second set of parameters associated with a second low power mode; and apply (1) the first low power mode based on one or more parameters in the first set of parameters exceeding the second set of parameters, or (2) the second low power mode based on the one or more parameters in the first set of parameters not exceeding the second set of parameters. In certain aspects, the base station 102 or the one or more location servers 168 may have an extended low power mode configuration component 199 that may be configured to provide configurations related to extended low power mode(s) to the UE 104.

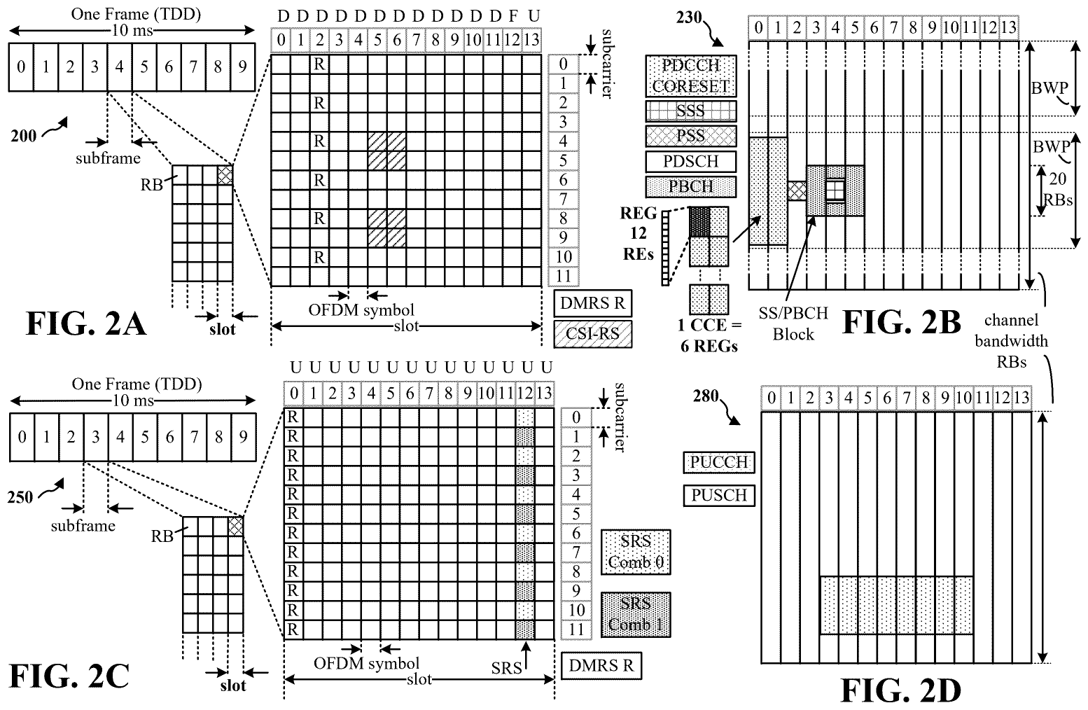

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

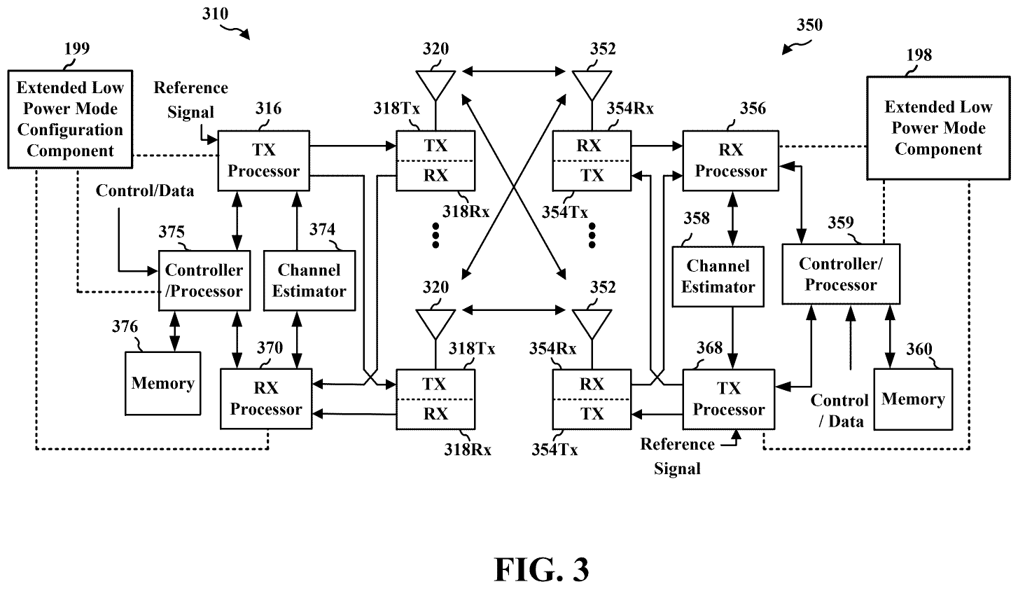

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the extended low power mode component 198 of FIG. 1.

At least one of the TX processor 316, the RX processor 370, and the controller/processor 375 may be configured to perform aspects in connection with the extended low power mode configuration component 199 of FIG. 1.

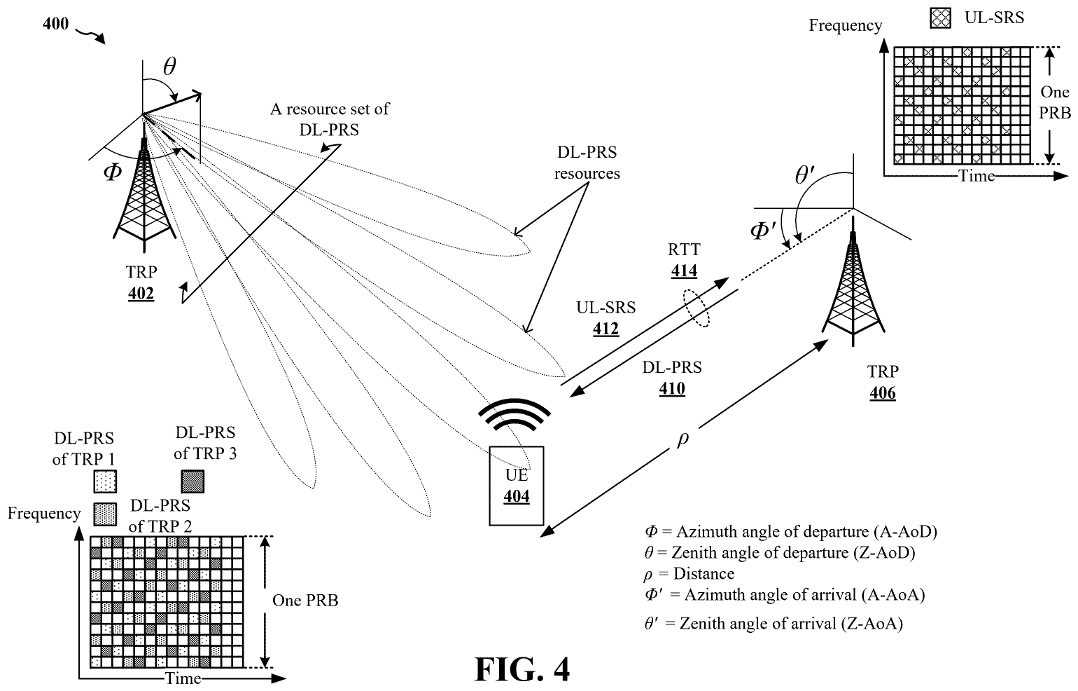

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on |T_{SRS_RX}−T_{PRS_TX}|−|T_{SRS_TX}−T_{PRS_RX}|. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

A device (e.g., a UE) equipped with a global navigation satellite system (GNSS) receiver may determine its location based on reception of signals from multiple satellites, which may be referred to as “GNSS positioning,” “GNSS-based positioning” or “satellite-based positioning,” etc. GNSS includes a network of satellites broadcasting timing and orbital information used for navigation and positioning measurements. In addition, GNSS may refer to the International Multi-Constellation Satellite System, which may include global positioning system (GPS), global navigation satellite system (GLONASS), BeiDou Navigation Satellite System (BDS), Galileo, and any other constellation system. GNSS may include multiple groups of satellites (which may be referred to as GNSS satellites), known as constellations, that broadcast signals (which may be referred to as GNSS signals) to control stations and users of the GNSS. Based on the broadcast signals, the users may be able to determine their locations (e.g., via a trilateration process). For purposes of the present disclosure, a device (e.g., a UE) that is equipped with a GNSS receiver or is capable of receiving GNSS signals may be referred to as a GNSS device, and a device that is capable of transmitting GNSS signals, such as a satellite, may be referred to as a space vehicle (SV).

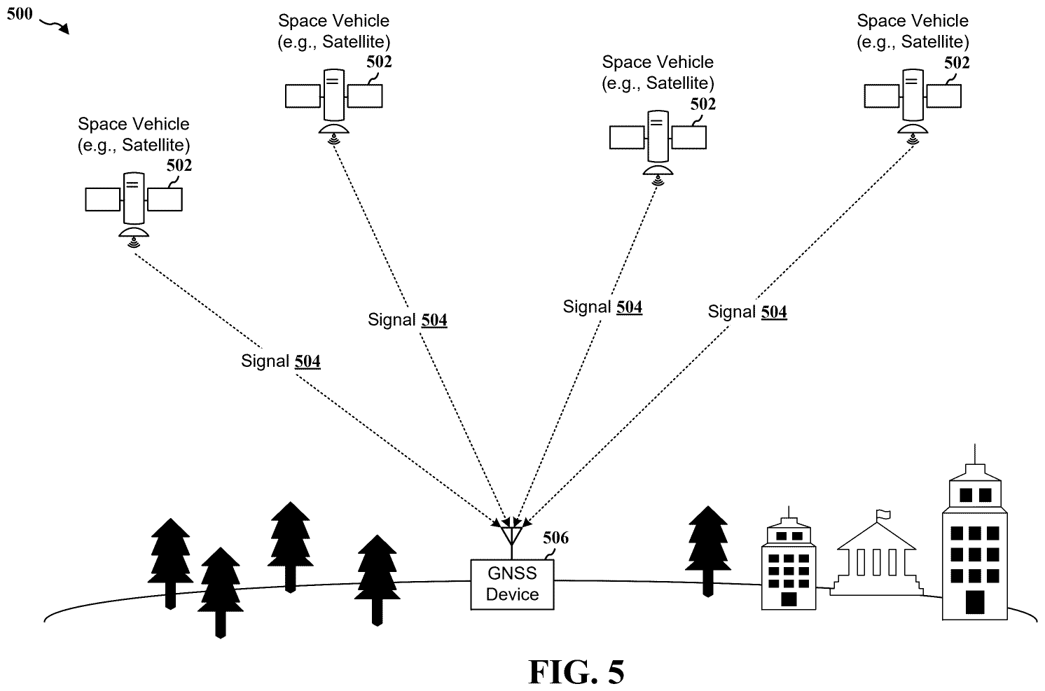

FIG. 5 is a diagram 500 illustrating an example of GNSS positioning in accordance with various aspects of the present disclosure. A GNSS device 506 may calculate its position and time based at least in part on data (e.g., GNSS signals 504) received from SVs 502, where each SV 502 may carry a record of its position and time and may transmit that data (e.g., the record) to the GNSS device 506. Each SV 502 may further include a clock that is synchronized with other clocks of SVs and with ground clock(s). If an SV 502 detects that there is a drift from the time maintained on the ground, the SV 502 may correct it. The GNSS device 506 may also include a clock, but the clock for the GNSS device 506 may be less stable and precise compared to the clocks for each SV 502.

As the speed of radio waves may be constant and independent of the satellite speed, a time delay between a time the SV 502 transmits a GNSS signal 504 and a time the GNSS device 506 receives the GNSS signal 504 may be proportional to the distance from the SV 502 to the GNSS device 506. In some examples, a minimum of four SVs may be used by the GNSS device 506 to compute/calculate one or more unknown quantities associated with positioning (e.g., three position coordinates and clock deviation from satellite time, etc.).

Each SV 502 may broadcast the GNSS signal 504 (e.g., a carrier wave with modulation) continuously that may include a pseudorandom code (e.g., a sequence of ones and zeros) which may be known to the GNSS device 506, and may also include a message that includes a time of transmission and the SV position at that time. In other words, each GNSS signal 504 may carry two types of information: time and carrier wave (e.g., a modulated waveform with an input signal to be electromagnetically transmitted). Based on the GNSS signals 504 received from each SV 502, the GNSS device 506 may measure the time of arrivals (ToAs) of the GNSS signals 504 and calculate the time of flights (ToFs) for the GNSS signals 504. Then, based on the ToFs, the GNSS device 506 may compute its three-dimensional position and clock deviation, and the GNSS device 506 may determine its position on the Earth. For example, the GNSS device 506's location may be converted to a latitude, a longitude, and a height relative to an ellipsoidal Earth model. These coordinates may be displayed, such as on a moving map display, or recorded or used by some other system, such as a vehicle guidance system.

While the distance between a GNSS device and an SV may be calculated based on the time it takes for a GNSS signal to reach the GNSS device, the SV's signal sequence may be delayed in relation to the GNSS device's sequence. Thus, in some examples, a delay may be applied to the GNSS device's sequence, such that the two sequences are aligned. For example, to calculate the delay, a GNSS device may align a pseudorandom binary sequence contained in the SV's signal to an internally generated pseudorandom binary sequence. As the SV's GNSS signal takes time to reach the GNSS device, the SV's sequence may be delayed in relation to the GNSS device's sequence. By increasingly delaying the GNSS device's sequence, the two sequences may eventually be aligned.

In recent years, vehicle manufacturers have been developing vehicles with assisted driving and/or autonomous driving capabilities. Assisted driving, which may also be called advanced driver assistance systems (ADAS), may refer to a set of technologies designed to enhance vehicle safety and improve the driving experience by providing assistance and automation to the driver. These technologies may use various sensor(s), such as camera(s), radar(s), light detection and ranging (lidar(s) or lidar sensor(s)), etc., and other components to monitor a vehicle's surroundings and assist the driver of the vehicle with certain driving tasks. For example, some features of assisted driving systems may include: (1) adaptive cruise control (ACC) (e.g., a system that automatically adjusts a vehicle's speed to maintain a safe following distance from the vehicle ahead), (2) lane-keeping assist (LKA) (e.g., a system that uses cameras to detect lane markings and helps keep the vehicle centered within the lane, and provides steering inputs to prevent unintentional lane departure), (3), autonomous emergency braking (AEB) (e.g., a system that detects potential collisions with obstacles or pedestrians and automatically apply the brakes to avoid or mitigate the impact), (4) blind spot monitoring (BSM) (e.g., a system that uses sensors to detect vehicles in a driver's blind spots and provides visual or audible alerts to avoid potential collisions during lane changes), (5) parking assistance (e.g., a system that assists drivers in parking their vehicles by using camera(s) and sensor(s) to help with parallel parking or maneuvering into tight spaces), and/or traffic sign recognition (e.g., camera(s) and image processing are used to recognize and display traffic signs such as speed limits, stop signs, and other road regulations on the vehicle's dashboard).

Autonomous driving, which may also be called as self-driving or driverless technology, may refer to the ability of a vehicle to navigate and operate itself without specifying human intervention (e.g., travelling from one place to another place without a human controlling the vehicle). The goal of the autonomous driving is to create vehicles that are capable of perceiving their surroundings, making decisions, and controlling their movements, all without the direct involvement of a human driver. To achieve or improve the autonomous driving, a vehicle may be specified to use a map (or map data) with detailed information, such as a high-definition (HD) map. An HD map may refer to a highly detailed and accurate digital map designed for use in autonomous driving and ADAS. In one example, HD maps may typically include one or more of: (1) geometric information (e.g., precise road geometry, including lane boundaries, curvature, slopes, and detailed 3D models of the surrounding environment), (2) lane-level information (e.g., information about individual lanes on the road, such as lane width, lane type (e.g., driving, turning, or parking lanes), and lane connectivity), (3) road attributes (e.g., data on road features like traffic signs, signals, traffic lights, speed limits, and road markings), (4) topology (e.g., information about the relationships between different roads, intersections, and connectivity patterns), (5) static objects (e.g., locations and details of fixed objects along the road, such as buildings, traffic barriers, and poles), (6) dynamic objects (e.g., real-time or frequently updated data about moving objects, like other vehicles, pedestrians, and cyclists), and/or (7) localization and positioning: precise reference points and landmarks that help in accurate vehicle localization on the map, etc. To keep the map data up-to-date, applications or devices using the map data, such as the autonomous/assisted driving systems, may be configured to download updated map data from a server from time to time or based on certain pre-defined conditions (e.g., when travelling to an area that is without map data). In some implementations, downloading map data from a server may be referred to as “map over the air” (MOTA).

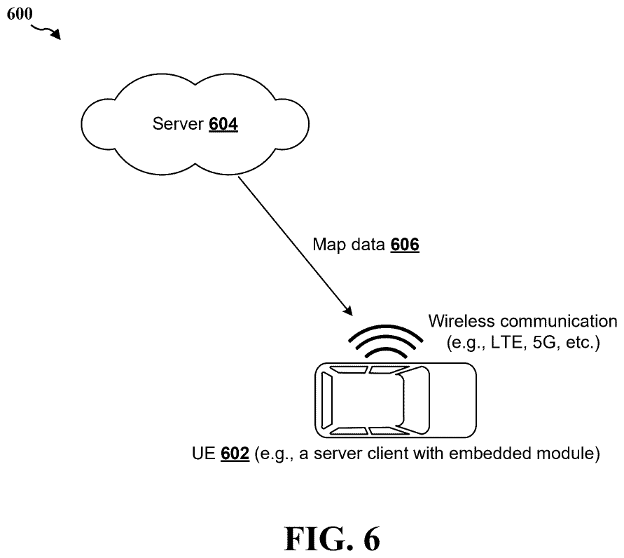

FIG. 6 is a diagram 600 illustrating an example of a vehicle performing map over the air in accordance with various aspects of the present disclosure. In one example, map over the air may refer to a process of a server 604 sending real-time map data 606 to a UE 602 (e.g., a vehicle, an assisted/autonomous driving system of the vehicle, an on-board unit (OBU) of the vehicle, an ADAS of the vehicle, a device running a navigation application, etc.) over a wireless network/communication (e.g., an LTE network, a 5G network, etc.), enabling the UE 602 to make decisions based on the latest information about the road and traffic conditions. In a typical implementation, the map data 606 is transmitted from the server 604 (e.g., a cloud-based system), where the server 604 may utilize sensors and other data sources to collect and analyze information about the road network and traffic patterns. This data is then processed and combined with other data, such as GPS/GNSS and/or camera data from multiple users (e.g., from other UEs/vehicles and/or the UE 602) to create a detailed map of the environment in real-time. Then, an application (e.g., for autonomous driving, navigation, positioning, etc.) of the UE 602 may access the map data 606 over a wireless network (e.g., a cellular or satellite network), and use the map data 606 to make decisions about speed, route, and other factors, etc. For example, the UE 602 may use the map data 606 to avoid road construction, traffic congestion, or accidents, and to optimize its route for efficiency and safety, etc.

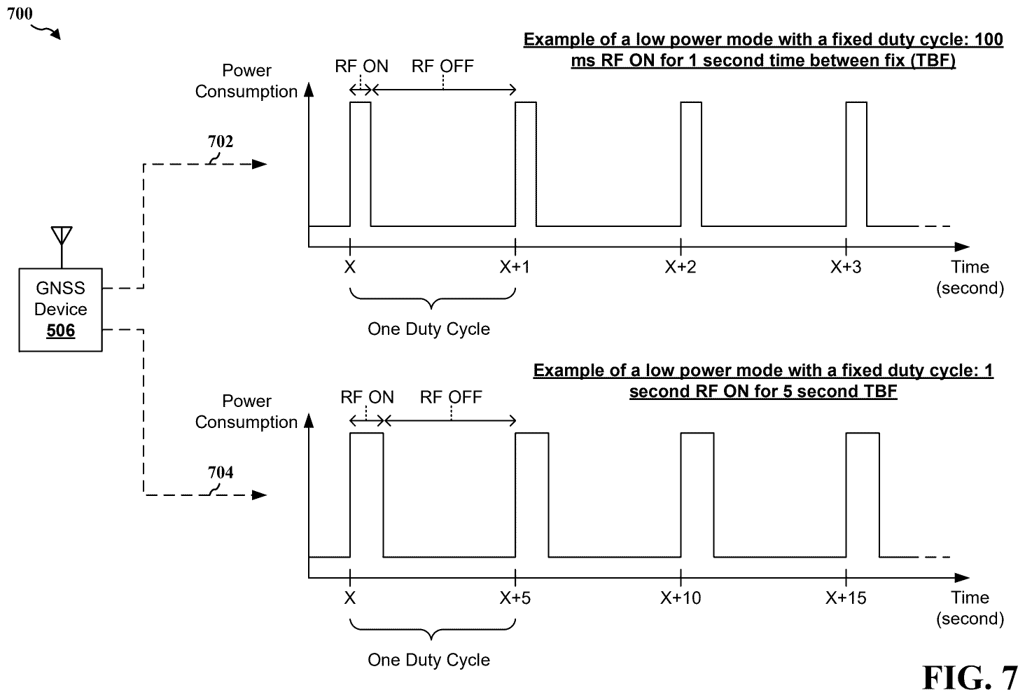

FIG. 7 is a diagram 700 illustrating an example of a low power mode associated with a GNSS device/receiver in accordance with various aspects of the present disclosure. Most GNSS devices/receivers may be configured with at least one low power mode to reduce the power consumption of the GNSS devices/receivers. A low power mode, which may also be referred to as the “lower power mode” and/or “power saving mode,” etc., may refer to a strategy/technology used to reduce the energy consumption of the GNSS device/receiver (while maintaining acceptable levels of positioning performance). The low power mode is typically important for battery-operated devices such as smartphones, wearables, and IoT devices where power efficiency may be important. Depending on implementations, a low power mode may be engaged based on the following: an environment context (e.g., carrier-to-noise density (C/NO) or positioning fix residuals, etc.), number of tracking SVs/SVs used in a fix, and/or number of SVs with valid broadcast data, etc. For purposes of the present disclosure, in the context of GNSS positioning, a “fix” or a “GNSS fix” may refer to the determination of a GNSS device/receiver's position at a specific point in time. For example, a fix may be a computed set of coordinates (e.g., latitude, longitude, and sometimes altitude) that represent the GNSS device/receiver's location based on signals received from GNSS SVs/satellites.

One example of the low power mode for a GNSS device/receiver to save power is the duty cycling, which may also be referred to as a duty-cycled tracking mode. When a GNSS device/receiver is configured with a duty-cycled tracking mode, the GNSS device/receiver may periodically turn off or reduce its activity to save power. For example, the receiver may just activate for brief periods to acquire and process satellite signals and then enter into a low-power state between these active periods, where each active period may be referred to as a duty cycle.

Typically, the low power mode is configured with a fixed duty cycle. For example, as shown at 702, if the GNSS device 506 is a mobile phone (or used for the mobile phone), the low power mode configured for the GNSS device 506 may include a fixed duty cycle with 100 millisecond RF ON for one (1) second time between fix (TBF). In another example, as shown at 704, if the GNSS device 506 is a wearable device (or used for the wearable device), the low power mode configured for the GNSS device 506 may include a fixed duty cycle with 1 second RF ON for five (5) second TBF. For purposes of the present disclosure and in the context of GNSS positioning, “time between fixes (TBF)” may refer to an interval of time between successive position fixes or updates, where a position fix/update is the process of determining the geographical location (e.g., latitude, longitude, and possibly altitude) of the GNSS device/receiver at a particular moment. In other words, TBF is a duration between two consecutive instances where the GNSS device/receiver computes its position. For example, if a GNSS device/receiver calculates its position every second, the TBF is 1 second.

Typically, the activation/initiation and/or the deactivation/termination of a low power mode (which may be referred to as the “low power mode entry/exit”) may be configured to be determined by a set of metrics derived from the measurements and/or position states. For example, the GNSS device 506 may be configured to activate a low power mode when the GNSS device 506's power falls below a power threshold, or when the positioning accuracy for the GNSS device 506 is reduced/relaxed (e.g., the GNSS device 506 does not specify high accuracy positioning). However, such configuration/mechanism may not be able to optimize the powering saving for the GNSS device 506 as the GNSS device 506 may demand different RF ON and/or TBF/duty cycle in different scenarios. For example, if the GNSS device 506 just supports a fixed duty cycle with 100 ms RF ON for 1 second TBF (e.g., as described in connection with 702 of FIG. 7), the power saving of the GNSS device 506 may not be optimized if the GNSS device 506 is able to provide/achieve the same positioning performance with a shorter (e.g., 50 ms) RF ON period and/or with a longer (e.g., 5 seconds) TBF in a duty cycle.

Aspects presented herein may improve the overall power saving for GNSS devices/receivers by enabling the GNSS devices/receivers to augment map data to determine the RF ON duration (in a duty cycle). Aspects presented herein may provide an adaptive TBF to extend the low power engagement time for GNSS devices/receivers. In other words, aspects presented herein may provide techniques for low power mode optimization for GNSS devices/receivers, which include at least the following aspects: (1) an adaptive low/lower power mode: in addition to the user position, environment context, uncertainty, TBF/RF ON/OFF duration may be optimized further based on user-speed/heading along with map data (as the position uncertainty growth can be strongly constrained along the direction of motion), and (2) availability of three dimensional (3D) map may further help optimize the TBF/RF OFF/ON duration, timing of the session ON, re-acquisition resource allocation based on the SV visibility. For example, at the start of a fresh fix session, a GNSS device/receiver may be configured to predict an SV visibility for a finite time horizon, and use the predicted SV visibility to modify the TBF/RF ON/OFF duration. In addition, the GNSS device/receiver may also be configured to consider quality of service (QOS) or accuracy specification in the determination of optimizing the TBF/RF ON parameters.

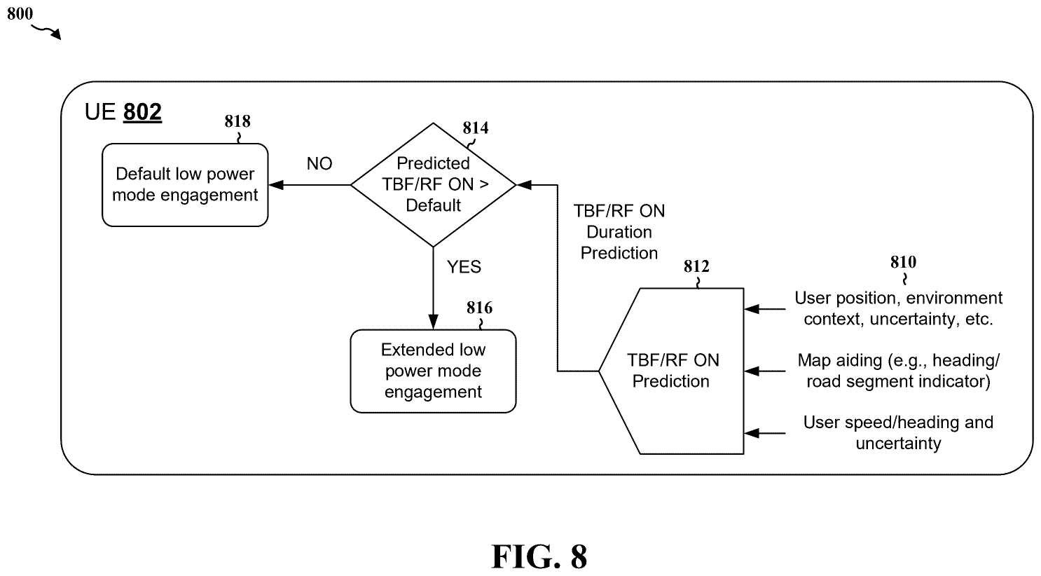

FIG. 8 is a diagram 800 illustrating an example of a map aided low power mode in accordance with various aspects of the present disclosure. In one aspect of the present disclosure, a UE 802 (e.g., a GNSS device/receiver, the GNSS device 506, a mobile phone, a wearable device, etc.) may be configured to predict its position for a finite time horizon (e.g., for a period time) based on its current position, velocity, and time (PVT) estimates/uncertainty and map data. Then, based on the predicted position (and using a propagation model based on the use-case), the UE 802 may estimate a user uncertainty the end of the prediction interval, where this uncertainty in the user-location and the acquisition resource in a low power mode is used by the UE 802 to determine a TBF, an RF ON duration, and/or an RF OFF duration (collectively as “TBF/RF ON duration” or “TBF/RF ON/OFF duration”). The adaptively determined TBF/RF ON/OFF duration described herein is better optimized (e.g., save more power) compared to a default fixed TBF used by the UE 802 (as described in connection with FIG. 7), because the adaptively determined TBF/RF ON/OFF duration, on an average, has an extended low power mode compared to the default fixed TBF. For example, if the UE 802 is navigating in a straight road segment in a pedestrian mode, the low power mode (e.g., the TBF and/or RF OFF duration of the low power mode) may be extended based on the user's speed/heading along with map data (as the position uncertainty growth can be strongly constrained along the direction of motion).

As an illustration, at 810, the UE 802 may obtain a set of information such as (1) the position of the UE 802, the environment context surrounding the UE 802, and their related uncertainties, (2) information from map data (which may be referred to as the “map aiding”) (e.g., heading, road segment indicator, etc.), and/or (3) the speed and heading of the UE 802 (or tis user) and their related uncertainties, etc. Depending on implementations, the UE 802 may obtain its position based on GNSS positioning, and/or based on any other positioning mechanisms such as the network-based positioning described in connection with FIG. 4. The UE 802 may obtain the environment context surrounding the UE 802, such as the traffics (e.g., high/low traffic) and/or types of the area (e.g., a densely populated area, a rural area, etc.), based on camera data, live traffic information, and/or map data, etc. As described in connection with FIG. 6, the UE 802 may obtain map related information from a server, where the map related information may include road and traffic information of the area(s) in which the UE 802 is heading toward. In some examples, to achieve this, the UE 802 may be configured to predict/estimate the trajectory of the UE 802, such as based on past movements of the UE 802. For example, if the UE 802 has been moving towards east in the past x minutes, the UE 802 is more likely to continue to move toward cast in the next y minutes compared to other directions (e.g., such as west). The UE 802 may obtain the speed/heading based on GNSS positioning, and/or based on sensors (e.g., speed sensor, inertial measurement unit (IMU), compass, camera, etc.).

At 812, based on the set of information obtained at 810, the UE 802 may be configured to predict, estimate, or calculate at least one of: (1) a TBF, or (2) an RF ON duration (or an RF OFF duration depending on implementations) (collectively as the “predicted TBF/RF ON/OFF duration”) associated with a duty cycle of a low power mode based on a set of criteria/conditions.

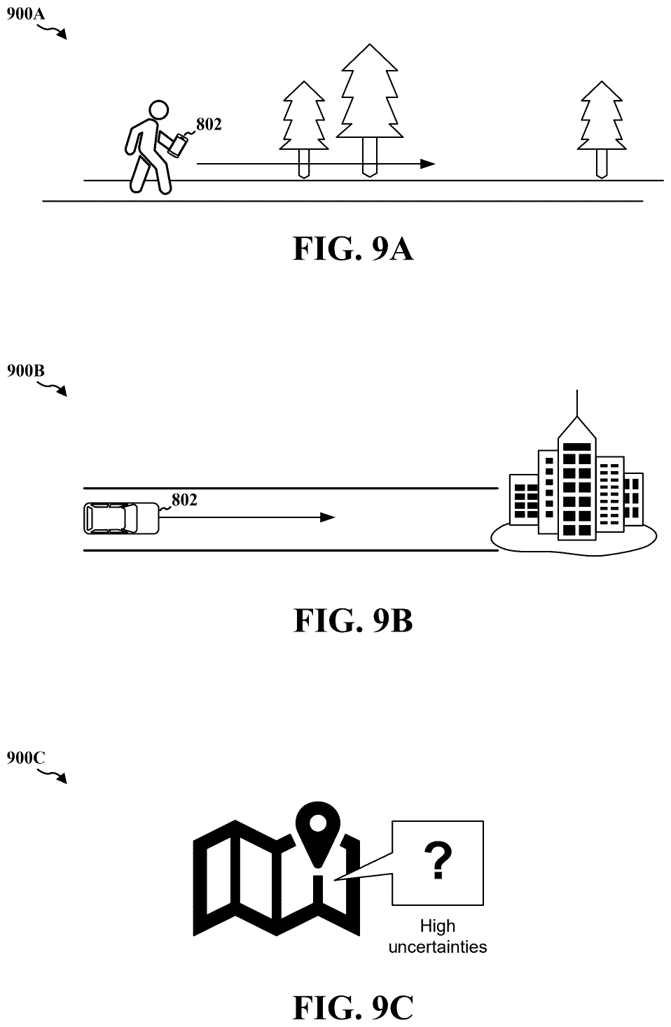

FIG. 9A is a diagram 900A illustrating an example scenario of predicting the TBF and/or the RF ON/OFF duration for a UE in accordance with various aspects of the present disclosure. In one example, based on the map data, the detected position of the UE 802, and/or the predicted movement of the UE 802, the UE 802 may determine that its user is a pedestrian walking in a rural/open sky area, and is likely to be walking in the similar condition for a defined period (e.g., for next x minutes), e.g., the rural/open sky area may continue for next y miles ahead of the UE 802. Then, based on this determination, the UE 802 may determine a longer TBF (e.g., 5 seconds, 10 seconds, 1 minute, etc.) and/or a short RF ON duration (or a longer RF OFF duration) for each duty cycle.

FIG. 9B is a diagram 900B illustrating an example scenario of predicting the TBF and/or the RF ON/OFF duration for a UE in accordance with various aspects of the present disclosure. In another example, based on the map data, the detected position of the UE 802, and/or the predicted movement of the UE 802, the UE 802 may determine that it is heading towards a densely populated area (e.g., from a highway into a city/urban area). Then, based on this information, the UE 802 may determine a shorter TBF (e.g., 2 seconds, 1 second, etc.) and/or a longer RF ON duration (or a shorter RF OFF duration) for each duty cycle.

FIG. 9C is a diagram 900C illustrating an example scenario of predicting the TBF and/or the RF ON/OFF duration for a UE in accordance with various aspects of the present disclosure. In another example, based on the map data, the detected position of the UE 802, and/or the predicted movement of the UE 802, the UE 802 may not be able to determine its speed, heading, and/or position with high certainty (e.g., the certainty is not above a threshold). For example, the UE 802 may be in an area with complex roads. In such scenarios, the UE 802 may determine a shorter TBF (e.g., 2 seconds, 1 second, etc.) and/or a longer RF ON duration (or a shorter RF OFF duration) for each duty cycle.

Referring back to FIG. 8, at 814, the UE 802 may be configured to compare the predicted TBF/RF ON/OFF duration with a default TBF/RF ON/OFF duration (e.g., a TBF/RF ON/OFF duration associated with a fixed duty cycle or a conventional low power mode as described in connection with FIG. 7). If the predicted TBF/RF ON/OFF duration is greater than the default TBF/RF ON/OFF duration or provides more power saving compared to the default TBF/RF ON/OFF duration (e.g., at least the TBF is longer or the RF ON duration is shorter or both depending on the implementation), as shown at 816, the UE 802 may be configured to engage/apply the predicted TBF/RF ON/OFF duration (which may be referred to as the “extended low power mode” for purposes of the present disclosure). For examples, the scenario discussed in connection with FIG. 9A may trigger/prompt the UE 802 to apply the extended low power mode.

On the other hand, if the predicted TBF/RF ON/OFF duration is less than (or equal to) the default TBF/RF ON/OFF duration (e.g., at least the TBF is shorter or the RF ON duration is longer or both depending on the implementation), as shown at 818, the UE 802 may be configured to engage/apply the default TBF/RF ON/OFF duration (which may be referred to as the “default low power mode” for purposes of the present disclosure). For examples, the scenario discussed in connection with FIGS. 9B and 9C may trigger/prompt the UE 802 to apply the default low power mode.

In some examples, the UE 802 may be configured to output an indication of an application of the extended low power mode or the default low power mode, such as transmit the indication of the application of the extended low power mode or the default low power mode, or store the indication of the application of the extended low power mode or the default low power mode.

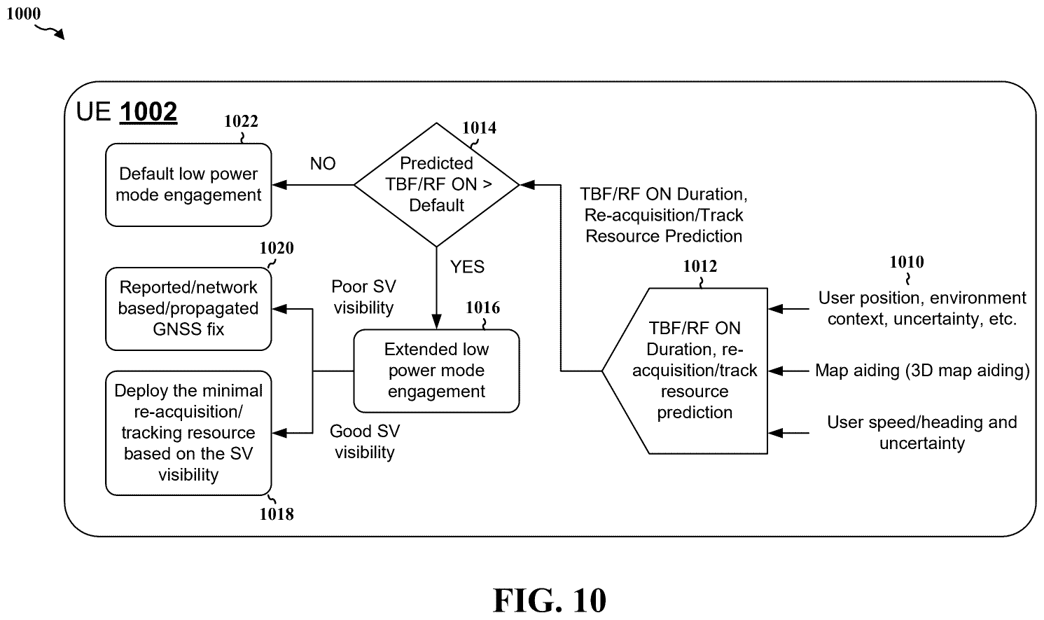

FIG. 10 is a diagram 1000 illustrating an example of a 3D map aided low power mode in accordance with various aspects of the present disclosure. In another aspect of the present disclosure, the availability of 3D map (or 3D map data) may further help a UE to optimize the prediction/estimation/calculation of the TBF/RF OFF/ON duration, the timing of the session start/ON (e.g., timing of initiating/reengaging GNSS positioning session), and the re-acquisition resource allocation based on the SV visibility. A 3D map data may refer to map data that include 3D information (in addition to information provided by 2D map data), such as the terrain/elevation information, the height/size of buildings, mountains, the depth of trenches, etc. In some examples, the 3D information may enable a UE to determine its RF conditions, such as whether the UE is in a high signal blockage area (e.g., the UE is surrounded by tall buildings and has low SV visibility) or in a low signal blockage area (e.g., the UE is in a clear sky area and has good SV visibility). For example, at the start of a fresh fix session/duty cycle (e.g., once per x seconds), based on the 3D map aiding/shadow matching, the UE may be able to predict the SV visibility for a finite time horizon/duration. If the UE determines there is a good SV visibility (e.g., the SV visibility is greater than a visibility threshold, the number of available SVs is above a number threshold, the (average) signal quality received from the available SVs is above a quality threshold, etc.), the UE may be configured to deploy minimal re-acquisition/track resources and estimate the fix. On the other hand, if the UE determines there is a poor SV visibility (e.g., the SV visibility is below the visibility threshold, the number of available SVs is below the number threshold, the (average) signal quality received from the available SVs is below the quality threshold, etc.), the UE may be configured to fall back to a crowd-sourced fix or a propagated fix. For purposes of the present disclosure, a crowd-source fix may refer to a fix that is gathered by a server from other UEs that are likely in proximity to the UE, and/or a fix that is from a nearby UE. A propagated fix may refer to a prior estimated GNSS position fix propagated to the current time stamp (e.g., it may use the prior estimate of user speed/sensors like IMU for propagation).

As an illustration, at 1010, a UE 1002 (e.g., the UE 802, a GNSS device/receiver, the GNSS device 506, a mobile phone, a wearable device, etc.) may be configured to obtain a set of information such as (1) the position of the UE 1002, the environment context surrounding the UE 1002, and their related uncertainties, (2) information from 3D map data (which may be referred to as the “3D map aiding”) (e.g., heading, road segment indicator, terrain information, height of buildings, etc.), and/or (3) the speed and heading of the UE 1002 (or tis user) and their related uncertainties, etc. Depending on implementations, the UE 1002 may obtain its position based on GNSS positioning, and/or based on any other positioning mechanisms such as the network-based positioning described in connection with FIG. 4. The UE 1002 may obtain the environment context surrounding the UE 1002, such as the traffics (e.g., high/low traffic) and/or types of the area (e.g., a densely populated area, a rural area, etc.), based on camera data, live traffic information, and/or map data, etc. As described in connection with FIG. 6, the UE 1002 may obtain map related information (e.g., 2D and 3D map related information) from a server, where the map related information may include road and traffic information of the area(s) in which the UE 1002 is heading toward. In some examples, to achieve this, the UE 1002 may be configured to predict/estimate the trajectory of the UE 1002, such as based on past movements of the UE 1002. For example, if the UE 1002 has been moving towards cast in the past x minutes, the UE 1002 is more likely to continue to move toward cast in the next y minutes compared to other directions (e.g., such as west). The UE 1002 may obtain the speed/heading based on GNSS positioning, and/or based on sensors (e.g., speed sensor, IMU, compass, camera, etc.).

At 1012, based on the set of information obtained at 1010, the UE 1002 may be configured to predict, estimate, or calculate a TBF and/or an RF ON duration (or an RF OFF duration depending on implementations) associated with a duty cycle of a low power mode and a re-acquisition/track resource (e.g., based on the SV visibility) (collectively as the “predicted TBF/RF ON/OFF duration and re-acquisition/track resource) based on a set of criteria/conditions.

At 1014, the UE 1002 may be configured to compare the predicted TBF/RF ON/OFF duration and the with a default TBF/RF ON/OFF duration (e.g., a TBF/RF ON/OFF duration associated with a fixed duty cycle or a conventional low power mode as described in connection with FIGS. 7 and 8). If the predicted TBF/RF ON/OFF duration is greater than the default TBF/RF ON/OFF duration or provides more power saving compared to the default TBF/RF ON/OFF duration (e.g., at least the TBF is longer or the RF ON duration is shorter or both depending on the implementation), as shown at 1016, the UE 1002 may be configured to engage/apply the predicted TBF/RF ON/OFF duration (which may be referred to as the “extended low power mode” for purposes of the present disclosure). For examples, the scenario discussed in connection with FIG. 9A may trigger/prompt the UE 1002 to apply the extended low power mode.

In addition, as shown at 1018, if the predicted re-acquisition/track resource indicates that there is a good SV visibility (e.g., the SV visibility is greater than a visibility threshold, the number of available SVs is above a number threshold, the (average) signal quality received from the available SVs is above a quality threshold, etc.), the UE 1002 may be configured to deploy minimal re-acquisition/tracking resources (e.g., use minimal SVs specified) for estimating a fix. However, as shown at 1020, if the predicted re-acquisition/track resource indicates that there is a poor SV visibility (e.g., the SV visibility is below the visibility threshold, the number of available SVs is below the number threshold, the (average) signal quality received from the available SVs is below the quality threshold, etc.), the UE 1002 may be configured to use a reported, network based, or propagated GNSS fix (if available) (collectively as a network-based GNSS fix). A network-based GNSS fix may include a fix that is acquired by a crowd-sourcing server from other UEs close to the UE 1002 (which may be referred to as a crowd-sourced fix), a fix that is from another UE (e.g., a UE with higher GNSS capability), or a prior estimated fix (e.g., stored in the UE 1002) propagated to the current timestamp, etc. The UE 1002 may determine to use a network-based GNSS fix because the poor SV visibility may prevent the UE 1002 from obtaining a fix that is better than the network-based GNSS fix.

Similarly, as shown at 1022, if the predicted TBF/RF ON/OFF duration is less than (or equal to) the default TBF/RF ON/OFF duration (e.g., at least the TBF is shorter or the RF ON duration is longer or both depending on the implementation), the UE 1002 may be configured to engage/apply the default TBF/RF ON/OFF duration (which may be referred to as the “default low power mode” for purposes of the present disclosure). For examples, the scenario discussed in connection with FIGS. 9B and 9C may trigger/prompt the UE 1002 to apply the default low power mode.

In some examples, the UE 1002 may be configured to output an indication of an application of the extended low power mode or the default low power mode, such as transmit the indication of the application of the extended low power mode or the default low power mode, or store the indication of the application of the extended low power mode or the default low power mode.

Aspects presented herein provide an adaptive TBF with increased engagement in a low power mode and user context-based power saving, which is capable of increasing battery life in UEs, such as wearable/IoT devices, and may also be extended to support automotive/electrical vehicles (EVs) as well.

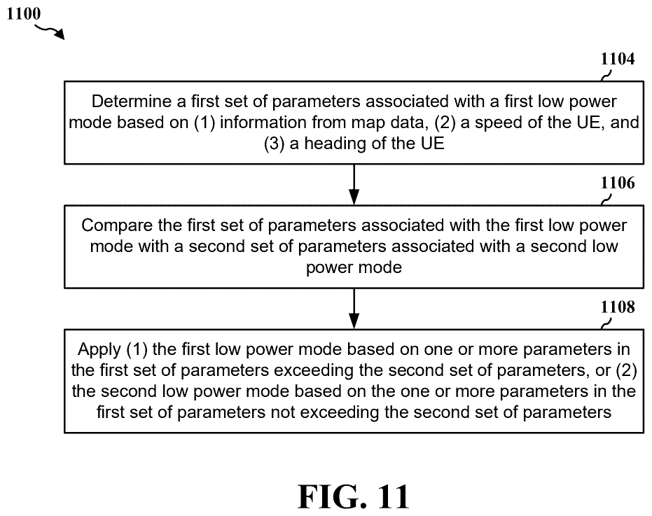

FIG. 11 is a flowchart 1100 of a method of at a user equipment (UE). The method may be performed by a UE (e.g., the UE 104, 404, 602, 802, 1002; the GNSS device 506; the apparatus 1304). The method may enable the UE to augment map data to determine the TBF and/or the RF ON/OFF duration for a duty cycle associated with a low power saving mode to further improve the overall power consumption of the UE.

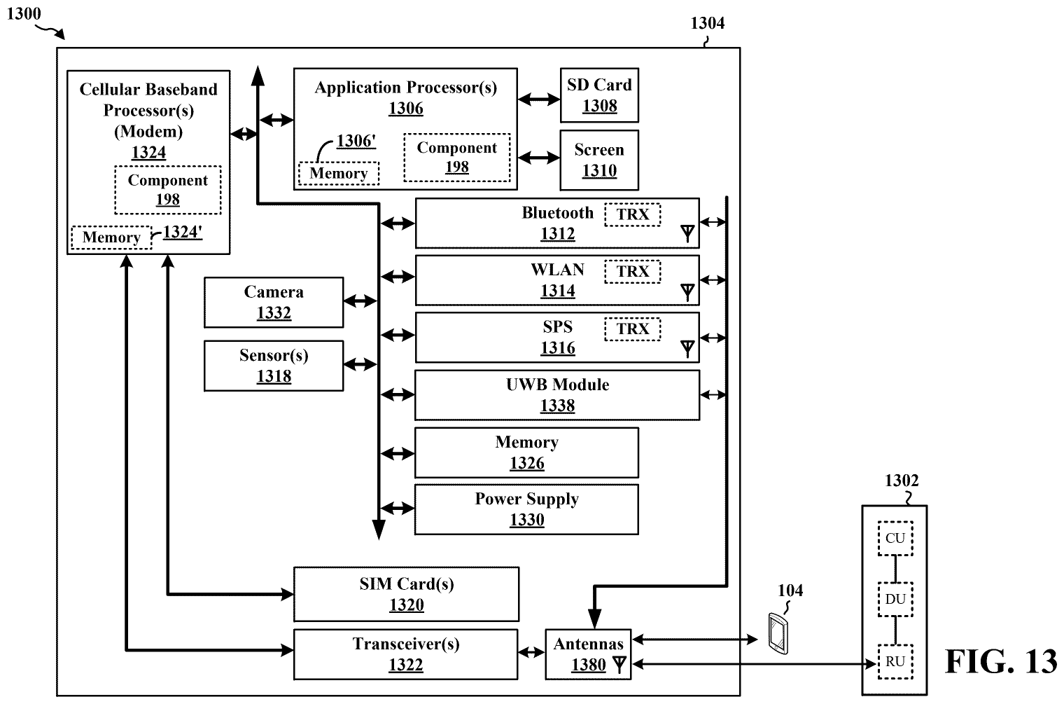

At 1104, the UE may determine a first set of parameters associated with a first low power mode based on (1) information from map data, (2) a speed of the UE, and (3) a heading of the UE, such as described in connection with FIGS. 8 and 10. For example, at 810 of FIG. 8, the UE 802 may obtain a set of information such as (1) the position of the UE 802, the environment context surrounding the UE 802, and their related uncertainties, (2) information from map data, and/or (3) the speed and heading of the UE 802 (or tis user) and their related uncertainties, etc. At 812, based on the set of information obtained at 810, the UE 802 may be configured to predict, estimate, or calculate at least one of: (1) a TBF, or (2) an RF ON duration (or an RF OFF duration depending on implementations) (collectively as the “predicted TBF/RF ON/OFF duration”) associated with a duty cycle of a low power mode based on a set of criteria/conditions. The determination of the first set of parameters may be performed by, e.g., the extended low power mode component 198, the SPS module 1316, the camera 1332, the one or more sensors 1318, the transceiver(s) 1322, the cellular baseband processor(s) 1324, and/or the application processor(s) 1306 of the apparatus 1304 in FIG. 13.

At 1106, the UE may compare the first set of parameters associated with the first low power mode with a second set of parameters associated with a second low power mode, such as described in connection with FIGS. 8 and 10. For example, at 814 of FIG. 8, the UE 802 may be configured to compare the predicted TBF/RF ON/OFF duration with a default TBF/RF ON/OFF duration (e.g., a TBF/RF ON/OFF duration associated with a fixed duty cycle or a conventional low power mode as described in connection with FIG. 7). The comparison of the first set of parameters associated with the first low power mode with the second set of parameters associated with the second low power mode may be performed by, e.g., the extended low power mode component 198, the SPS module 1316, the camera 1332, the one or more sensors 1318, the transceiver(s) 1322, the cellular baseband processor(s) 1324, and/or the application processor(s) 1306 of the apparatus 1304 in FIG. 13.

At 1108, the UE may apply (1) the first low power mode based on one or more parameters in the first set of parameters exceeding the second set of parameters, or (2) the second low power mode based on the one or more parameters in the first set of parameters not exceeding the second set of parameters, such as described in connection with FIGS. 8 and 10. For example, if the predicted TBF/RF ON/OFF duration is greater than the default TBF/RF ON/OFF duration or provides more power saving compared to the default TBF/RF ON/OFF duration, as shown at 816 of FIG. 8, the UE 802 may be configured to engage/apply the predicted TBF/RF ON/OFF duration. On the other hand, if the predicted TBF/RF ON/OFF duration is less than (or equal to) the default TBF/RF ON/OFF duration, as shown at 818, the UE 802 may be configured to engage/apply the default TBF/RF ON/OFF duration. The application of the first low power mode or the second low power mode may be performed by, e.g., the extended low power mode component 198, the SPS module 1316, the camera 1332, the one or more sensors 1318, the transceiver(s) 1322, the cellular baseband processor(s) 1324, and/or the application processor(s) 1306 of the apparatus 1304 in FIG. 13.

In one example, the first low power mode is associated with a configurable duty cycle, and the second low power mode is associated with a fixed duty cycle.

In another example, the determination of the first set of parameters associated with the first low power mode is further based on at least one of a position of the UE or an environment context.

In another example, the first set of parameters includes at least one of a first duration for activating RF or a TBF, and the second set of parameters includes at least one of a second duration for activating RF or a second TBF.

In another example, the determination of the first set of parameters associated with the first low power mode is further based on an uncertainty associated with the speed or the heading of the UE.

In another example, the first set of parameters includes a first set of resources for re-acquisition or tracking and at least one of a first duration for activating RF or a first TBF, and the second set of parameters includes a second set of resources for the re-acquisition or the tracking and at least one of a second duration for activating RF or a second TBF.

In another example, the first low power mode is applied based on the one or more parameters in the first set of parameters exceeding the second set of parameters.

In some implementations, the UE may predict an SV visibility based on the information from the map data, and deploy a minimal set of resources for re-acquisition or tracking based on the predicted SV visibility exceeding an SV visibility threshold, such as described in connection with FIG. 10. For example, at 1018, if the predicted re-acquisition/track resource indicates that there is a good SV visibility (e.g., the SV visibility is greater than a visibility threshold, the number of available SVs is above a number threshold, the (average) signal quality received from the available SVs is above a quality threshold, etc.), the UE 1002 may be configured to deploy minimal re-acquisition/tracking resources (e.g., use minimal SVs specified) for estimating a fix. The prediction of the SV visibility and/or the deployment of the minimal set of resources for re-acquisition or tracking may be performed by, e.g., the extended low power mode component 198, the SPS module 1316, the camera 1332, the one or more sensors 1318, the transceiver(s) 1322, the cellular baseband processor(s) 1324, and/or the application processor(s) 1306 of the apparatus 1304 in FIG. 13.

In some implementations, the UE may predict an SV visibility based on the information from the map data, and apply a network-based GNSS fix based on the predicted SV visibility being below an SV visibility threshold, such as described in connection with FIG. 8. For example, at 1020, if the predicted re-acquisition/track resource indicates that there is a poor SV visibility (e.g., the SV visibility is below the visibility threshold, the number of available SVs is below the number threshold, the (average) signal quality received from the available SVs is below the quality threshold, etc.), the UE 1002 may be configured to use a reported, network based, or propagated GNSS fix (if available) (collectively as a network-based GNSS fix). The prediction of the SV visibility and/or the use of the application of the network-based GNSS fix may be performed by, e.g., the extended low power mode component 198, the SPS module 1316, the camera 1332, the one or more sensors 1318, the transceiver(s) 1322, the cellular baseband processor(s) 1324, and/or the application processor(s) 1306 of the apparatus 1304 in FIG. 13.

In another example, the UE may obtain the map data from a server, and measure the speed and the heading of the UE, such as described in connection with FIGS. 8 and 10. For example, the UE 802 may obtain map related information from a server, where the map related information may include road and traffic information of the area(s) in which the UE 802 is heading toward. The UE 802 may obtain the speed/heading based on GNSS positioning, and/or based on sensors (e.g., speed sensor, IMU, compass, camera, etc.). The obtainment of the map data and/or the measurement of the speed and the heading may be performed by, e.g., the extended low power mode component 198, the SPS module 1316, the camera 1332, the one or more sensors 1318, the transceiver(s) 1322, the cellular baseband processor(s) 1324, and/or the application processor(s) 1306 of the apparatus 1304 in FIG. 13.

In another example, the UE may output an indication of an application of the first low power mode or the second low power mode. In some implementations, to output the indication of the application of the first low power mode or the second low power mode, the UE may be configured to transmit the indication of the application of the first low power mode or the second low power mode, or store the indication of the application of the first low power mode or the second low power mode.

In another example, the first low power mode is capable of providing more power saving compared to the second low power mode.

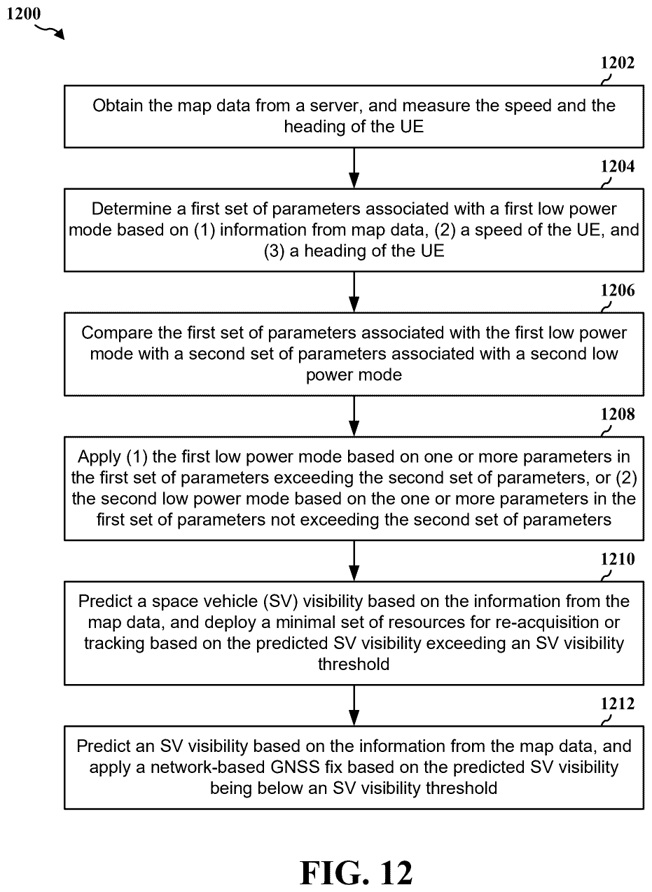

FIG. 12 is a flowchart 1200 of a method of at a user equipment (UE). The method may be performed by a UE (e.g., the UE 104, 404, 602, 802, 1002; the GNSS device 506; the apparatus 1304). The method may enable the UE to augment map data to determine the TBF and/or the RF ON/OFF duration for a duty cycle associated with a low power saving mode to further improve the overall power consumption of the UE.

At 1204, the UE may determine a first set of parameters associated with a first low power mode based on (1) information from map data, (2) a speed of the UE, and (3) a heading of the UE, such as described in connection with FIGS. 8 and 10. For example, at 810 of FIG. 8, the UE 802 may obtain a set of information such as (1) the position of the UE 802, the environment context surrounding the UE 802, and their related uncertainties, (2) information from map data, and/or (3) the speed and heading of the UE 802 (or tis user) and their related uncertainties, etc. At 812, based on the set of information obtained at 810, the UE 802 may be configured to predict, estimate, or calculate at least one of: (1) a TBF, or (2) an RF ON duration (or an RF OFF duration depending on implementations) (collectively as the “predicted TBF/RF ON/OFF duration”) associated with a duty cycle of a low power mode based on a set of criteria/conditions. The determination of the first set of parameters may be performed by, e.g., the extended low power mode component 198, the SPS module 1316, the camera 1332, the one or more sensors 1318, the transceiver(s) 1322, the cellular baseband processor(s) 1324, and/or the application processor(s) 1306 of the apparatus 1304 in FIG. 13.

At 1206, the UE may compare the first set of parameters associated with the first low power mode with a second set of parameters associated with a second low power mode, such as described in connection with FIGS. 8 and 10. For example, at 814 of FIG. 8, the UE 802 may be configured to compare the predicted TBF/RF ON/OFF duration with a default TBF/RF ON/OFF duration (e.g., a TBF/RF ON/OFF duration associated with a fixed duty cycle or a conventional low power mode as described in connection with FIG. 7). The comparison of the first set of parameters associated with the first low power mode with the second set of parameters associated with the second low power mode may be performed by, e.g., the extended low power mode component 198, the SPS module 1316, the camera 1332, the one or more sensors 1318, the transceiver(s) 1322, the cellular baseband processor(s) 1324, and/or the application processor(s) 1306 of the apparatus 1304 in FIG. 13.

At 1208, the UE may apply (1) the first low power mode based on one or more parameters in the first set of parameters exceeding the second set of parameters, or (2) the second low power mode based on the one or more parameters in the first set of parameters not exceeding the second set of parameters, such as described in connection with FIGS. 8 and 10. For example, if the predicted TBF/RF ON/OFF duration is greater than the default TBF/RF ON/OFF duration or provides more power saving compared to the default TBF/RF ON/OFF duration, as shown at 816 of FIG. 8, the UE 802 may be configured to engage/apply the predicted TBF/RF ON/OFF duration. On the other hand, if the predicted TBF/RF ON/OFF duration is less than (or equal to) the default TBF/RF ON/OFF duration, as shown at 818, the UE 802 may be configured to engage/apply the default TBF/RF ON/OFF duration. The application of the first low power mode or the second low power mode may be performed by, e.g., the extended low power mode component 198, the SPS module 1316, the camera 1332, the one or more sensors 1318, the transceiver(s) 1322, the cellular baseband processor(s) 1324, and/or the application processor(s) 1306 of the apparatus 1304 in FIG. 13.

In one example, the first low power mode is associated with a configurable duty cycle, and the second low power mode is associated with a fixed duty cycle.

In another example, the determination of the first set of parameters associated with the first low power mode is further based on at least one of a position of the UE or an environment context.

In another example, the first set of parameters includes at least one of a first duration for activating RF or a TBF, and the second set of parameters includes at least one of a second duration for activating RF or a second TBF.

In another example, the determination of the first set of parameters associated with the first low power mode is further based on an uncertainty associated with the speed or the heading of the UE.

In another example, the first set of parameters includes a first set of resources for re-acquisition or tracking and at least one of a first duration for activating RF or a first TBF, and the second set of parameters includes a second set of resources for the re-acquisition or the tracking and at least one of a second duration for activating RF or a second TBF.

In another example, the first low power mode is applied based on the one or more parameters in the first set of parameters exceeding the second set of parameters.

In some implementations, as shown at 1210, the UE may predict an SV visibility based on the information from the map data, and deploy a minimal set of resources for re-acquisition or tracking based on the predicted SV visibility exceeding an SV visibility threshold, such as described in connection with FIG. 10. For example, at 1018, if the predicted re-acquisition/track resource indicates that there is a good SV visibility (e.g., the SV visibility is greater than a visibility threshold, the number of available SVs is above a number threshold, the (average) signal quality received from the available SVs is above a quality threshold, etc.), the UE 1002 may be configured to deploy minimal re-acquisition/tracking resources (e.g., use minimal SVs specified) for estimating a fix. The prediction of the SV visibility and/or the deployment of the minimal set of resources for re-acquisition or tracking may be performed by, e.g., the extended low power mode component 198, the SPS module 1316, the camera 1332, the one or more sensors 1318, the transceiver(s) 1322, the cellular baseband processor(s) 1324, and/or the application processor(s) 1306 of the apparatus 1304 in FIG. 13.

In some implementations, as shown at 1212, the UE may predict an SV visibility based on the information from the map data, and apply a network-based GNSS fix based on the predicted SV visibility being below an SV visibility threshold, such as described in connection with FIG. 8. For example, at 1020, if the predicted re-acquisition/track resource indicates that there is a poor SV visibility (e.g., the SV visibility is below the visibility threshold, the number of available SVs is below the number threshold, the (average) signal quality received from the available SVs is below the quality threshold, etc.), the UE 1002 may be configured to use a reported, network based, or propagated GNSS fix (if available) (collectively as a network-based GNSS fix). The prediction of the SV visibility and/or the use of the application of the network-based GNSS fix may be performed by, e.g., the extended low power mode component 198, the SPS module 1316, the camera 1332, the one or more sensors 1318, the transceiver(s) 1322, the cellular baseband processor(s) 1324, and/or the application processor(s) 1306 of the apparatus 1304 in FIG. 13.

In another example, as shown at 1202, the UE may obtain the map data from a server, and measure the speed and the heading of the UE, such as described in connection with FIGS. 8 and 10. For example, the UE 802 may obtain map related information from a server, where the map related information may include road and traffic information of the area(s) in which the UE 802 is heading toward. The UE 802 may obtain the speed/heading based on GNSS positioning, and/or based on sensors (e.g., speed sensor, IMU, compass, camera, etc.). The obtainment of the map data and/or the measurement of the speed and the heading may be performed by, e.g., the extended low power mode component 198, the SPS module 1316, the camera 1332, the one or more sensors 1318, the transceiver(s) 1322, the cellular baseband processor(s) 1324, and/or the application processor(s) 1306 of the apparatus 1304 in FIG. 13. In another example, the UE may output an indication of an application of the first low power mode or the second low power mode. In some implementations, to output the indication of the application of the first low power mode or the second low power mode, the UE may be configured to transmit the indication of the application of the first low power mode or the second low power mode, or store the indication of the application of the first low power mode or the second low power mode.

In another example, the first low power mode is capable of providing more power saving compared to the second low power mode.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include at least one cellular baseband processor 1324 (also referred to as a modem) coupled to one or more transceivers 1322 (e.g., cellular RF transceiver). The cellular baseband processor(s) 1324 may include at least one on-chip memory 1324′. In some aspects, the apparatus 1304 may further include one or more subscriber identity modules (SIM) cards 1320 and at least one application processor 1306 coupled to a secure digital (SD) card 1308 and a screen 1310. The application processor(s) 1306 may include on-chip memory 1306′. In some aspects, the apparatus 1304 may further include a Bluetooth module 1312, a WLAN module 1314, an ultrawide band (UWB) module 1338, an SPS module 1316 (e.g., GNSS module), one or more sensors 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the UWB module 1338, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor(s) 1324 communicates through the transceiver(s) 1322 via one or more antennas 1380 with the UE 104 and/or with an RU associated with a network entity 1302. The cellular baseband processor(s) 1324 and the application processor(s) 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor(s) 1324 and the application processor(s) 1306 are each responsible for general processing, including the execution of software stored on the computer-readable medium/memory. The software, when executed by the cellular baseband processor(s) 1324/application processor(s) 1306, causes the cellular baseband processor(s) 1324/application processor(s) 1306 to perform the various functions described supra. The cellular baseband processor(s) 1324 and the application processor(s) 1306 are configured to perform the various functions described supra based at least in part of the information stored in the memory. That is, the cellular baseband processor(s) 1324 and the application processor(s) 1306 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1324/application processor(s) 1306 when executing software. The cellular baseband processor(s) 1324/application processor(s) 1306 may be a component of the UE 350 and may include the at least one memory 360 and/or at least one of the TX processor 368, the RX processor 356, and the controller/processor 359. In one configuration, the apparatus 1304 may be at least one processor chip (modem and/or application) and include just the cellular baseband processor(s) 1324 and/or the application processor(s) 1306, and in another configuration, the apparatus 1304 may be the entire UE (e.g., see UE 350 of FIG. 3) and include the additional modules of the apparatus 1304.

As discussed supra, the extended low power mode component 198 may be configured to determine a first set of parameters associated with a first low power mode based on (1) information from map data, (2) a speed of the UE, and (3) a heading of the UE. The extended low power mode component 198 may also be configured to compare the first set of parameters associated with the first low power mode with a second set of parameters associated with a second low power mode. The extended low power mode component 198 may also be configured to apply (1) the first low power mode based on one or more parameters in the first set of parameters exceeding the second set of parameters, or (2) the second low power mode based on the one or more parameters in the first set of parameters not exceeding the second set of parameters. The extended low power mode component 198 may be within the cellular baseband processor(s) 1324, the application processor(s) 1306, or both the cellular baseband processor(s) 1324 and the application processor(s) 1306. The extended low power mode component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1304 may include a variety of components configured for various functions. In one configuration, the apparatus 1304, and in particular the cellular baseband processor(s) 1324 and/or the application processor(s) 1306, may include means for determining a first set of parameters associated with a first low power mode based on (1) information from map data, (2) a speed of the UE, and (3) a heading of the UE. The apparatus 1304 may further include means for comparing the first set of parameters associated with the first low power mode with a second set of parameters associated with a second low power mode. The apparatus 1304 may further include means for applying (1) the first low power mode based on one or more parameters in the first set of parameters exceeding the second set of parameters, or (2) the second low power mode based on the one or more parameters in the first set of parameters not exceeding the second set of parameters.

In one configuration, the first low power mode is associated with a configurable duty cycle, and the second low power mode is associated with a fixed duty cycle.

In another configuration, the determination of the first set of parameters associated with the first low power mode is further based on at least one of a position of the UE or an environment context.

In another configuration, the first set of parameters includes at least one of a first duration for activating RF or a TBF, and the second set of parameters includes at least one of a second duration for activating RF or a second TBF.

In another configuration, the determination of the first set of parameters associated with the first low power mode is further based on an uncertainty associated with the speed or the heading of the UE.

In another configuration, the first set of parameters includes a first set of resources for re-acquisition or tracking and at least one of a first duration for activating RF or a first TBF, and the second set of parameters includes a second set of resources for the re-acquisition or the tracking and at least one of a second duration for activating RF or a second TBF.

In another configuration, the first low power mode is applied based on the one or more parameters in the first set of parameters exceeding the second set of parameters.

In some implementations, the apparatus 1304 may further include means for predicting an SV visibility based on the information from the map data, and means for deploying a minimal set of resources for re-acquisition or tracking based on the predicted SV visibility exceeding an SV visibility threshold.

In some implementations, the apparatus 1304 may further include means for predicting an SV visibility based on the information from the map data, and means for applying a network-based GNSS fix based on the predicted SV visibility being below an SV visibility threshold.

In another configuration, the apparatus 1304 may further include means for obtaining the map data from a server, and means for measuring the speed and the heading of the UE.

In another configuration, the apparatus 1304 may further include means for outputting an indication of an application of the first low power mode or the second low power mode. In some implementations, the means for outputting the indication of the application of the first low power mode or the second low power mode may include configuring the apparatus 1304 to transmit the indication of the application of the first low power mode or the second low power mode, or store the indication of the application of the first low power mode or the second low power mode.

In another configuration, the first low power mode is capable of providing more power saving compared to the second low power mode.

The means may be the extended low power mode component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication, comprising: determining a first set of parameters associated with a first low power mode based on (1) information from map data, (2) a speed of the UE, and (3) a heading of the UE; comparing the first set of parameters associated with the first low power mode with a second set of parameters associated with a second low power mode; and applying (1) the first low power mode based on one or more parameters in the first set of parameters exceeding the second set of parameters, or (2) the second low power mode based on the one or more parameters in the first set of parameters not exceeding the second set of parameters.

Aspect 2 is the method of aspect 1, wherein the first low power mode is associated with a configurable duty cycle, and wherein the second low power mode is associated with a fixed duty cycle.

Aspect 3 is the method of aspect 1 or aspect 2, wherein the determination of the first set of parameters associated with the first low power mode is further based on at least one of a position of the UE or an environment context.

Aspect 4 is the method of any of aspects 1 to 3, wherein the first set of parameters includes at least one of a first duration for activating radio frequency (RF) or a first time-between-fix (TBF), and wherein the second set of parameters includes at least one of a second duration for activating RF or a second TBF.

Aspect 5 is the method of any of aspects 1 to 4, wherein the determination of the first set of parameters associated with the first low power mode is further based on an uncertainty associated with the speed or the heading of the UE.

Aspect 6 is the method of any of aspects 1 to 5, wherein the first set of parameters includes a first set of resources for re-acquisition or tracking and at least one of a first duration for activating radio frequency (RF) or a first time-between-fix (TBF), and wherein the second set of parameters includes a second set of resources for the re-acquisition or the tracking and at least one of a second duration for activating RF or a second TBF.

Aspect 7 is the method of any of aspects 1 to 6, wherein the first low power mode is applied based on the one or more parameters in the first set of parameters exceeding the second set of parameters.

Aspect 8 is the method of any of aspects 1 to 7, further comprising: predicting a space vehicle (SV) visibility based on the information from the map data; and deploying a minimal set of resources for re-acquisition or tracking based on the predicted SV visibility exceeding an SV visibility threshold.

Aspect 9 is the method of any of aspects 1 to 8, further comprising: predicting a space vehicle (SV) visibility based on the information from the map data; and applying a network-based GNSS fix based on the predicted SV visibility being below an SV visibility threshold.

Aspect 10 is the method of any of aspects 1 to 9, further comprising: obtaining the map data from a server; and measuring the speed and the heading of the UE.

Aspect 11 is the method of any of aspects 1 to 10, further comprising: outputting an indication of an application of the first low power mode or the second low power mode.

Aspect 12 is the method of any of aspects 1 to 11, wherein outputting the indication of applying the first low power mode or the second low power mode comprises: transmitting the indication of the application of the first low power mode or the second low power mode; or storing the indication of the application of the first low power mode or the second low power mode.

Aspect 13 is the method of any of aspects 1 to 12, wherein the first low power mode is capable of providing more power saving compared to the second low power mode.

Aspect 14 is an apparatus for wireless communication at a user equipment (UE), including: at least one memory; and at least one processor coupled to the at least one memory and, based at least in part on information stored in the at least one memory, the at least one processor, individually or in any combination, is configured to implement any of aspects 1 to 13.

Aspect 15 is the apparatus of aspect 14, further including at least one transceiver coupled to the at least one processor.

Aspect 16 is an apparatus for wireless communication at a user equipment (UE), including means for implementing any of aspects 1 to 13.

Aspect 17 is a computer-readable medium (e.g., a non-transitory computer-readable medium) storing computer executable code, where the code when executed by a processor causes the processor to implement any of aspects 1 to 13.

What is claimed is:

1. An apparatus for wireless communication at a user equipment (UE), comprising:
at least one memory; and
at least one processor coupled to the at least one memory, the at least one processor, individually or in any combination, is configured to:
determine a first set of parameters associated with a first low power mode based on (1) information from map data, (2) a speed of the UE, and (3) a heading of the UE;
compare the first set of parameters associated with the first low power mode with a second set of parameters associated with a second low power mode; and
apply (1) the first low power mode based on one or more parameters in the first set of parameters exceeding the second set of parameters, or (2) the second low power mode based on the one or more parameters in the first set of parameters not exceeding the second set of parameters.

2. The apparatus of claim 1, wherein the first low power mode is associated with a configurable duty cycle, and wherein the second low power mode is associated with a fixed duty cycle.

3. The apparatus of claim 1, wherein determination of the first set of parameters associated with the first low power mode is further based on at least one of a position of the UE or an environment context.

4. The apparatus of claim 1, wherein the first set of parameters includes at least one of a first duration for activating radio frequency (RF) or a first time-between-fix (TBF), and wherein the second set of parameters includes at least one of a second duration for activating RF or a second TBF.

5. The apparatus of claim 1, wherein determination of the first set of parameters associated with the first low power mode is further based on an uncertainty associated with the speed or the heading of the UE.

6. The apparatus of claim 1, wherein the first set of parameters includes a first set of resources for re-acquisition or tracking and at least one of a first duration for activating radio frequency (RF) or a first time-between-fix (TBF), and wherein the second set of parameters includes a second set of resources for the re-acquisition or the tracking and at least one of a second duration for activating RF or a second TBF.

7. The apparatus of claim 1, wherein the first low power mode is applied based on the one or more parameters in the first set of parameters exceeding the second set of parameters.

8. The apparatus of claim 7, wherein the at least one processor, individually or in any combination, is further configured to:
predict a space vehicle (SV) visibility based on the information from the map data; and
deploy a minimal set of resources for re-acquisition or tracking based on the predicted SV visibility exceeding an SV visibility threshold.

9. The apparatus of claim 7, wherein the at least one processor, individually or in any combination, is further configured to:
predict a space vehicle (SV) visibility based on the information from the map data; and
apply a network-based GNSS fix based on the predicted SV visibility being below an SV visibility threshold.

10. The apparatus of claim 1, wherein the at least one processor, individually or in any combination, is further configured to:
obtain the map data from a server; and
measure the speed and the heading of the UE.

11. The apparatus of claim 1, wherein the at least one processor, individually or in any combination, is further configured to:
output an indication of an application of the first low power mode or the second low power mode.

12. The apparatus of claim 11, wherein to output the indication of applying the first low power mode or the second low power mode, the at least one processor, individually or in any combination, is configured to:
transmit the indication of the application of the first low power mode or the second low power mode; or
store the indication of the application of the first low power mode or the second low power mode.

13. The apparatus of claim 1, wherein the first low power mode is capable of providing more power saving compared to the second low power mode.

14. A method of positioning at a user equipment (UE), comprising:
determining a first set of parameters associated with a first low power mode based on (1) information from map data, (2) a speed of the UE, and (3) a heading of the UE;
comparing the first set of parameters associated with the first low power mode with a second set of parameters associated with a second low power mode; and
applying (1) the first low power mode based on one or more parameters in the first set of parameters exceeding the second set of parameters, or (2) the second low power mode based on the one or more parameters in the first set of parameters not exceeding the second set of parameters.

15. The method of claim 14, wherein the first set of parameters includes at least one of a first duration for activating radio frequency (RF) or a first time-between-fix (TBF), and wherein the second set of parameters includes at least one of a second duration for activating RF or a second TBF.

16. The method of claim 14, wherein the first set of parameters includes a first set of resources for re-acquisition or tracking and at least one of a first duration for activating radio frequency (RF) or a first time-between-fix (TBF), and wherein the second set of parameters includes a second set of resources for the re-acquisition or the tracking and at least one of a second duration for activating RF or a second TBF.

17. The method of claim 14, wherein the first low power mode is applied based on the one or more parameters in the first set of parameters exceeding the second set of parameters.

18. The method of claim 17, further comprising:
predicting a space vehicle (SV) visibility based on the information from the map data; and
deploying a minimal set of resources for re-acquisition or tracking based on the predicted SV visibility exceeding an SV visibility threshold, or applying a network-based GNSS fix based on the predicted SV visibility being below the SV visibility threshold.

19. The method of claim 14, further comprising:
obtaining the map data from a server; and
measuring the speed and the heading of the UE.

20. A computer-readable medium storing computer executable code, the code when executed by at least one processor causes the at least one processor to:
determine a first set of parameters associated with a first low power mode based on (1) information from map data, (2) a speed of a user equipment (UE), and (3) a heading of the UE;
compare the first set of parameters associated with the first low power mode with a second set of parameters associated with a second low power mode; and
apply (1) the first low power mode based on one or more parameters in the first set of parameters exceeding the second set of parameters, or (2) the second low power mode based on the one or more parameters in the first set of parameters not exceeding the second set of parameters.
